(19) United States
(12) Patent Application Publication
(10) Pub. No.: US 2024/0050316 A1
(43) Pub. Date: Feb. 15, 2024

(54) Methods and Apparatus to Improve Efficiency of Injectable Drug Delivery

(71) Applicant: Congruence Medical Solutions, LLC, Hanover, MD (US)

(72) Inventor: Gautam Nithyanand Shetty, Hanover, MD (US)

(73) Assignee: Congruence Medical Solutions, LLC, Hanover, MD (US)

(21) Appl. No.: 18/258,058

(22) PCT Filed: Dec. 17, 2021
(86) PCT No.: PCT/US21/64235

§ 371 Date: Jun. 16, 2023

Related U.S. Application Data
(60) Provisional application No. 63/127,828, filed on Dec. 18, 2020.

(51) Int. Cl. A61J 1/20; A61J 1/14

(52) U.S. Cl. CPC A61J 1/2096; A61J 1/201; A61J 1/2048; A61J 1/1406

(57) ABSTRACT

Methods for administration of injectable fluids and a vial adapter for use with an injector and a vial containing the fluid. The adapter includes a vial retainer, a spacing disc, and a spacing arm. The vial retainer is sized to receive at least a portion of the vial, the stopper and the stopper retainer of the vial. The spacing disc includes a needle insertion port, and is spaced a predetermined distance from the vial retainer by the spacing arm. A distance an injector needle inserted through the port may extend through the stopper is limited by contact of the injector with the spacing disc.

### CROSS-REFERENCE TO RELATED APPLICATIONS

This application claims priority to U.S. Provisional Application 63/127,828 filed Dec. 18, 2020, which is incorporated herein by reference for all it discloses.

### FIELD OF INVENTION

The invention generally deals with devices to facilitate methods for transfer and delivery of injectable therapeutics, and more specifically to arrangements for minimizing waste inherent in drug preparation and administration procedures wherein an injectable fluid is transferred from a single or multi dose vial into a syringe or a device incorporating a syringe for subsequent injection

### BACKGROUND

Vials are one of the most widely used containers for drug and vaccine storage. A vial-based storage container system typically consists of a vial, an elastomeric stopper and a crimp seal or stopper retainer. A drug vial for an injectable fluid consists of cylindrical vial made of glass or plastic, an elastomeric stopper and Cap/Seal. The Cap/Seal consists of a plastic lid and an aluminum crimp. Drug is filled into the vial in an automated filling line under aseptic conditions. This is then sealed with an elastomeric stopper. The stopper is then secured with a Cap/Seal using a crimping step. The drug vial has completed the fill finish process and is sent to the use site after labeling and enclosed in a secondary package (e.g., a box). When the user receives the vial, they remove the plastic lid and use an alcohol swab to sanitize the exposed portion of the stopper. In the case where the injection needle is same as the transfer needle, the needle is attached the syringe and inserted into the septum. The vial is inverted and the drug is drawn into the syringe by pulling the plunger rod of the syringe. The volume of drug drawn is conventionally higher than the volume of drug intended for injection into the patient. The initial stroke draws air into the syringe; the volume is this air corresponds to the dead space in the transfer needle and the syringe. This air is followed by drug drawn from the vial with the syringe and drawn needle oriented upwards. The vial is then detached, the user advances the plunger rod until the air is purged and a drop(s) is(are) visible—this is needle priming. The user then further advances the plunger rod until the stopper aligns with the dose reference marking corresponding to the intended dose volume; markings are printed on the external surface of the syringe barrel. In applications where injection and transfer needle are different, the aforementioned priming step is preceded by a step to substitute the transfer needle with the injection needle. In a setup involving a conventional vial adapter, the vial adapter substitutes the aforementioned transfer needle.

The dimensions and materials of these vials and associated components typically confirm to an industry standard such as ISO 8362. Conformance to this standard ensures compatibility for integration with equipment for filling the injectable substance, stoppering and its eventual storage in the a vial. Depending on the number of doses that can be drawn from a vial, vials can either be a single dose vials (SDV) or multi-dose vials (MDV). MDVs contain two or more doses.

Dead space in a syringe or needle is the volume in the syringe and needle, where typically the drug product remains undelivered at the end of injection. The volume of drug filled in a vial is usually determined as the sum total of indicated dose volume, dead space in syringe, dead space in the injection needle and dead space in any drug transfer devices (e.g., filter needle, connectors, vial adaptors, etc.) employed. In the case of MDVs, the effect of dead space is multiplied by a factor equal to or greater than the number of doses intended to be contained within the vial. The volume of drug (or vaccine) that is not injected but provided in the drug vial is called “overfill” volume. The overfill is small relative to dose volume for injections greater than 50 microliters (0.5 milliliter). For small dose volumes, however, the overfill can be significant relative to the volume of the dose. In the example of a drug Luxturna, only on the order of 6% of the drug filled in the vial is ultimately injected into the patient. That is, on the order of 94% of the vial fill volume is wasted. This waste occurs at the point of drug administration.

There is tremendous effort and expenses involved filling and finishing of sterile pharmaceutical drugs; this includes materials, facility, energy, storage, etc. Minimizing overfill, and hence waste, can result in significant cost savings. Minimizing overfill waste can be important in relation to injectable agents used as emergency countermeasures such as pandemic vaccines and therapeutics. Minimizing vaccine waste at the point of use during a pandemic can help inoculate population faster in order to control pandemic spread. Given the amount of energy involved in the manufacture, storage and supply of a drug/vaccine, minimizing waste at point of injection is also a sustainability imperative. The bottom-line is that overfill equals waste; the overfill volume is never injected into a patient.

Unfortunately, overfill requirements have also been encoded into industry standards that prescribe the total volume of drug to be filled in a vial including the overfill. One such industry standard is “USP (US Pharmacopeia) General Chapter <1151> Pharmaceutical Dosage Forms”. Compliance to this standard in some instances can also be part of a recommendation by regulatory agencies. This USP standard prescribes the volume of injectable substance (drug or vaccine) to be filled to be stored in a vial; this filled volume is always greater than the indicated dose volume. Most regulatory agencies require that overfill ensures that a complete dose is always delivered. Summarized in below, is the overfill volume corresponding to indicated dose volume as prescribed by USP <1151>.

TABLE 1

| Intended Dose | Overfill per Dose | Overfill per Dose as |
|---|---|---|
| (milliliter) | (milliliter) | % of Intended Dose |
| A | B | A/B |
| 0.5 | 0.1 | 20% |
| 1.0 | 0.1 | 10% |
| 2.0 | 0.15 | 8% |
| 5.0 | 0.3 | 6% |
| 10.0 | 0.5 | 5% |
| 20.0 | 0.6 | 3% |
| 30.0 | 0.8 | 3% |
| ≥50.0 | 1 | >2% |

For a microliter volume drugs (for example, drugs injected into the eye), the overfill volume is disproportionately larger than the indicated injection volume. Based on published regulatory filings, similar information for a drug injected in the eye, with an indicated dose volume of 0.05 mL is also included. Based on the USP<1151>, the overfill volume as a proportion of indicated dose shows an increasing trend as the indicated dose volume gets smaller—i.e., smaller the dose volume, greater is the amount of drug wasted to account for dead space.

This overfill volume is simply an accommodation for anticipated dead space in the preparation and injection of the indicated volume. The overfill as a percentage of the intended dose volume increases with decreasing dose volume. This percentage increase is greater if the injectable formulation is viscous compared to a lower (waterlike) viscosity formulation having the same indicated dose volume.

Extrapolating for multiple doses based on the above, each intended injection volume to be drawn from a multidose vial (such as vaccines), an overfill corresponding to each dose intended to be delivered from the multi dose vial has to accounted for during manufacturing. In some instances, the overfill in the case of multidose vials can exceed or equal volume corresponding to a full indicated dose. In instances where drugs are expensive or in short supply, the ability to minimize overfill requirement and/or to minimize impact of dead space in delivery systems may have tremendous utility.

Need to overfill a drug in a vial has significant operational and cost implications for pharmaceutical companies. The bottom line is that drug overfill is drug that is wasted or unused and yet travels through the entire supply chain continuum. There are significant overheads involved in the procurement, manufacture and supply of drugs, and yet at the end of the day the drug overfill volume goes undelivered to the patient.

Thus, injectable therapeutics filled in vials have certain inherent waste using devices and techniques in the prior art and current practice at time of this disclosure. This waste is magnified when the injection volumes are less than 1 milliliter. For multi dose vials waste is cumulative to the point where this cumulative waste may be greater than a dose or multiple doses. Minimizing or eliminating this waste can have a significant impact on access, cost of care, and increasing utilization efficiencies at point of care. This waste is mostly to counteract the presence of dead space in the syringe, injection conduit (needle, catheter, other) and transfer needle/device. More the number of components in the drug administration continuum, greater is the dead-space and associated waste. In addition, the amount of dead space is not same from one injection device manufacturer to another. This uncertainty further requires pharmaceutical manufacturers to overfill as a contingency for an injection component having the highest dead space.

During manufacture of injectable drugs, there is usually a fixed total starting amount (volume) of drug, which is then allocated into multiple vials by filling equipment. The total number of vials from this total starting amount typically constitutes as one drug production batch. Need for overfill volume limits the drug product yield from a production batch. By decreasing the amount of overfill required, the fixed overheads costs are amortized over increased number of drug product, reducing the overhead costs per unit of manufactured drug product. Significant costs are involved in the manufacture of injectable pharmaceutical agents. These costs are more acute for injectable drugs to be investigated during clinical trials. With ever-increasing costs of injectable drugs and expensive drugs in the development pipeline, it is essential to identify means to efficiently use and distribute such drugs.

The prior art includes vial adapters that claim to reduce the amount of overfill necessary in a vial and to enable the user to draw and inject an accurate dose. These vial adapters have a spike feature to puncture the vial septum creating a conduit to draw. However, these vial adapters can be employed only for single-dose vials. Vial adapters in the prior art cannot be used with a multi dose vial, especially when there are time gaps between one dose and another drawn dose. Another disadvantage is that the conventional vial adapter from the prior art has to be packaged and shipped separately increasing packaging footprint and increasing shipping costs. The vial adapters in the prior art also require sterilization, and must be supplied to the end user in a sterile form.

Accordingly, there is a need for an arrangement wherein a complete dose may be delivered while minimizing or eliminating overfill that would be acceptable from a regulatory standpoint.

### INVENTION SUMMARY

This disclosure in one aspect is directed to a vial adapter for use with an injector and a vial containing an injectable fluid, the vial including a stopper and a stopper retainer, the injector including a barrel and a needle. The vial adapter includes a vial retainer, a spacing disc, and a spacing arm. The vial retainer includes a generally cylindrical structure having a central opening. The vial retainer is sized to receive at least a portion of the vial, the stopper and the stopper retainer. The spacing disc includes a needle insertion port. The needle insertion port is sized to permit the passage of the needle and not to allow the passage of the barrel. The spacing arm is attached to the vial retainer and the spacing disc. The spacing arm is sized to space the spacing disc a predetermined distance from the vial retainer. When the needle of the injector is inserted through the needle insertion port and into the stopper, a distance that the needle may extend through the stopper is limited by contact of the injector with the spacing disc.

In another aspect, this disclosure is directed to a method of administering a single dose of an injectable fluid to a target. The method includes transferring a single dose of the injectable fluid to an injector, the injector having dead space containing dead space air, vertically orienting the injector over a target, inserting an injection needle of the injector into the target while maintaining the injector in a vertical orientation, administering the injectable fluid to the target, and removing the injection needle from the target while maintaining the dead space air within the injector.

In yet another aspect, this disclosure is directed to a method of transfer and administration of injectable fluid wherein, transfer from a vial into an injector involves injection of air from the injector into the vial approximately equal to intended dose volume followed by an injector draw stroke exactly equal to the intended dose volume, followed by administration of injectable fluid such that volume of air substantially equal to dead space of the injector is retained in the injector at the end of delivery of injectable fluid.

### BRIEF DESCRIPTION OF FIGURES

FIG. 1A is a fragmentary isometric view a vial of the prior art.

FIG. 1B is a cross-sectional view of the vial of FIG. 1A.

FIG. 2A is a cross-sectional view of a syringe engaged with a vial of the prior art.

FIGS. 2B and 2C are fragmentary, enlarged cross-sectional views of a needle of the syringe inserted into an elastomeric stopper of the vial of FIG. 2A.

FIG. 3A is an isometric view of a vial adapter according to aspects of this disclosure.

FIG. 3B is an isometric view of the vial adapter of FIG. 3A engaged with a vial.

FIGS. 4A and 4B are side elevational views of the vial adapter of FIGS. 3A and 3B in assembly to the vial.

FIG. 4C is a side elevational view of the vial adapter of FIGS. 3A-4B assembled to the vial.

FIG. 5A is an isometric view of the vial adapter of FIGS. 3A-4C.

FIG. 5B is a side elevational view of the vial adapter of FIGS. 3A-5A.

FIG. 5C is a top view of the vial adapter of FIGS. 3A-5B.

FIG. 5D is a front view of the vial adapter of FIGS. 3A-5C.

FIG. 5E is a bottom view of the vial adapter of FIGS. 3A-5D.

FIGS. 6A-H are isometric and side elevational views of a syringe in use with the vial adapter of FIGS. 3A-5E coupled to a vial.

FIGS. 7A-7D are side elevational views of an alternative embodiment of a vial adapter according to this disclosure, the components of the vial adapter being illustrated in various positions.

FIG. 8A is an enlarged, fragmentary, isometric view of a spacing disc of the vial adapter of FIGS. 7A-7D.

FIG. 8B is an enlarged, fragmentary, isometric view of the interlock arrangement between a spacing arm and a vial retainer of the vial adapter of FIGS. 7A-8A.

FIG. 8C is an isometric view of the vial adapter of FIGS. 7A-8B.

FIG. 9 is a side elevational view and enlarged fragmentary side elevational view of a prior art method of extracting an injectable fluid from a vial.

FIG. 10A is a side elevational view of another alternative embodiment of a vial adapter according to teachings of this disclosure in assembly with a vial.

FIG. 10B is a side elevational view of the vial adapter and vial of FIG. 10A positioned for extracting an injectable fluid from the vial.

FIGS. 11A-11C are a series of isometric views of the vial adapter of FIGS. 10A-10B from different angles.

FIGS. 12A-12C are side elevational views of a syringe in use with the vial adapter of FIGS. 10A-11C coupled to a vial.

### DETAILED DESCRIPTION

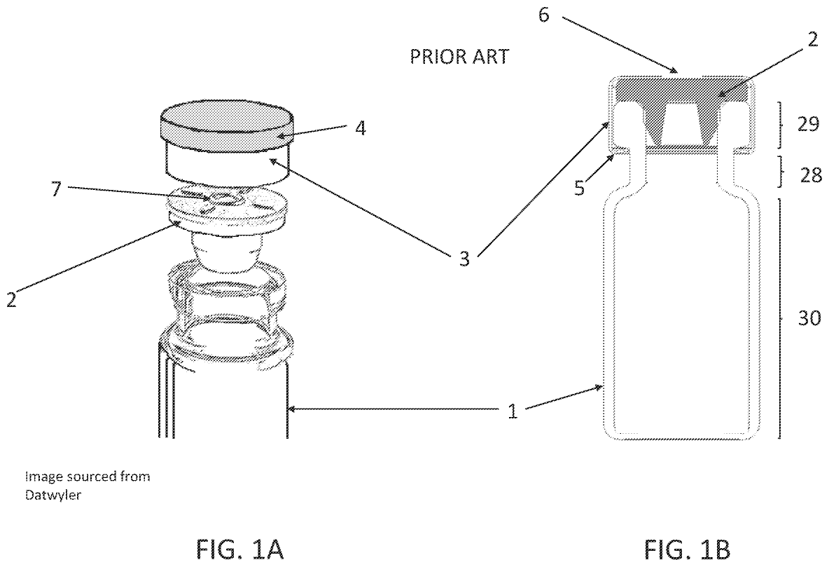

Shown in FIG. 1 are components of a vial consisting of vial 1, which typically is made of glass or a polymer, such as cyclic olefin polymer or the like. An injectable drug is contained in it. The vial 1 is closed using an elastomeric stopper 2. The elastomeric stopper 2 is then secured to the vial 1 using a crimp or stopper retainer 3, which is usually made out of aluminum. Stopper retainer 3 is deformed radially inwards under the rim 5 of the vial 1 slightly compressing and securing the stopper 2. Stopper retainer 3 has a circular hole 6 covered by a lid or cap 4. Prior to use, the user removes cap 4 to expose septum portion 7 of the stopper 2.

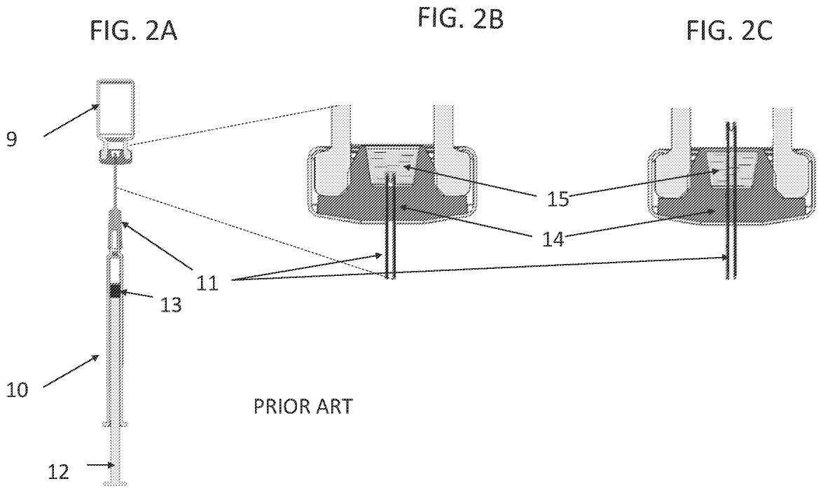

FIG. 2A is a sectional view of a syringe 10 and transfer needle 11 engaged with a vial 9 for use in drawing an injectable fluid 15 from the vial 9. With the transfer needle 11 extending through the hole 6 of the stopper retainer 3 and piercing through the elastomeric stopper 2, withdrawing the plunger rod 12 of the syringe 10 transfers injectable fluid 15 from the vial 9 into the syringe 10. A plunger stopper 13 is typically connected to the plunger rod 12 and helps create a seal within the barrel of the syringe 10. When needle 11 is inserted into the vial 9, the vial septum 14 seals around the needle 11. When the plunger rod 12 is withdrawn, it pulls the plunger seal 13 with it, creating negative pressure relative to the inside of the vial 9. This pressure differential drives flow of injectable fluid 15 from the vial 9 into the syringe 10 as long as the tip of the transfer needle 11 as shown in FIG. 2B is fully submerged in the injectable fluid 15.

If the tip of transfer needle 11 is not submerged in the injectable fluid 15, however, as shown in FIG. 2C, then negative pressure created by the withdrawal of plunger rod 12 results in transfer of air instead of injectable fluid from the vial 9 into the syringe 10. This may result in insufficient volume of injectable fluid 15 to be administered to the patient and/or leaves behind and wastes some of the injectable fluid 15 in the vial 9. Ideally, the user should be able to position deterministically the tip of the transfer needle 11 just past vial stopper 14. However, since this location is not visible to within the vial 9, elastomeric stopper 2 and the stopper retainer 3, the tip of the transfer needle 11 cannot be easily visualized. This is one source of injectable fluid waste.

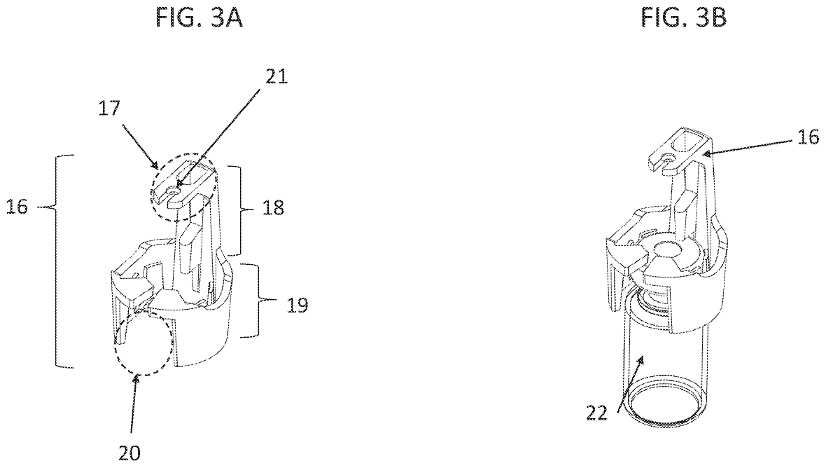

In accordance with the invention, there is provided a vial adapter to facilitate deterministically placing a transfer needle into a vial. Turning first to FIGS. 3A and 3B, there is illustrated an embodiment of a vial adapter 16 for placement of the transfer needle into a vial 22. Unlike vial adapters from the prior art, the disclosed vial adapter does not include a vial septum piercing component. The vial septum is pierced by transfer needle attached to a syringe in case of the disclosed invention.

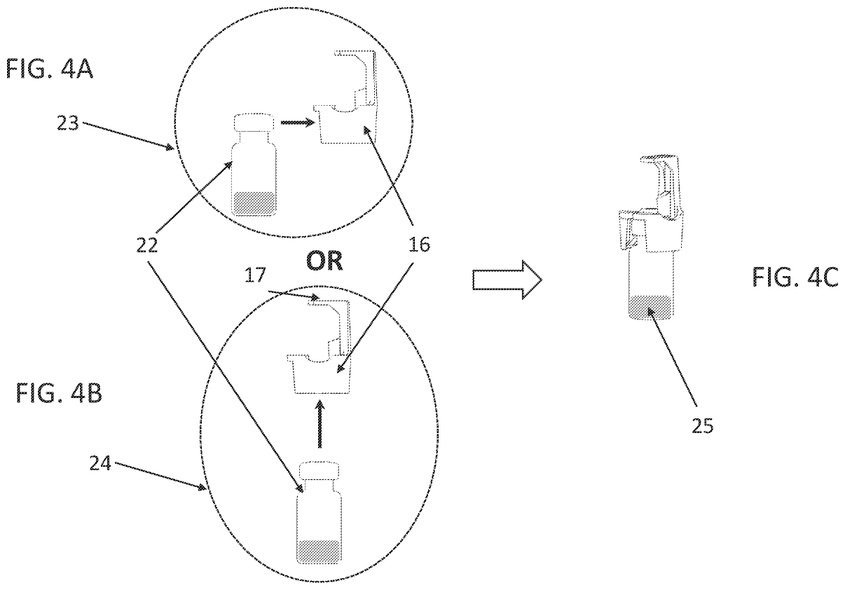

Shown in FIG. 3A, the vial adapter 16 comprises, first, a spacing disc 17, second, a spacing arm 18 and third, a vial retainer 19. In at least one embodiment, the vial retainer 19 is a generally cylindrical structure and includes a radial insertion port 20 for transverse vial insertion (see also FIG. 4A) and an axial insertion port for axial vial insertion defined by the generally annular structure of the vial retainer 19 (see also FIG. 4B). The spacing disc 17 is spaced from the vial retainer 19 by the spacing arm 18, and includes a transfer needle insertion port 21. Shown in FIG. 3B is the vial adapter 16 attached to a vial 22.

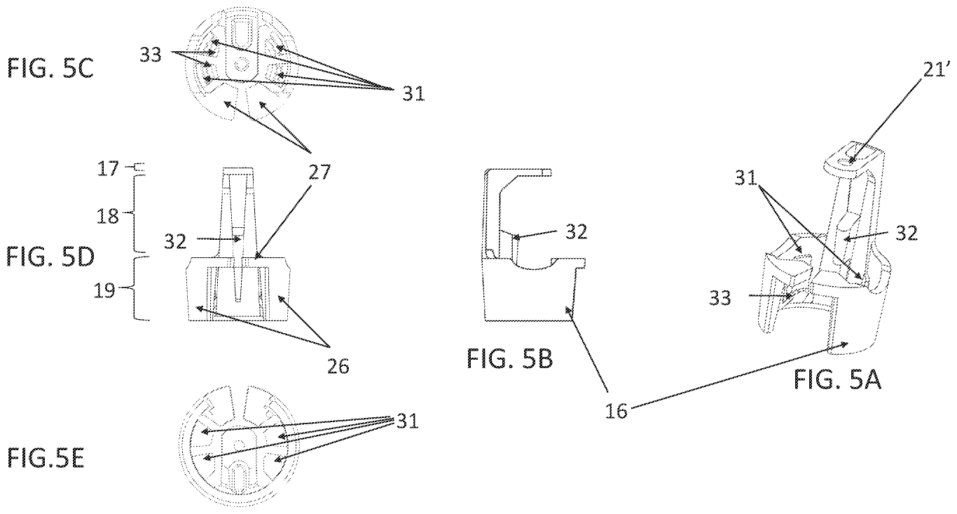

The needle insertion port 21 may be of any appropriate design that permits the passage of a transfer needle. In FIGS. 5A-5E, for example, the needle insertion port 21′ includes an annular aperture. In FIG. 3A, however, the needle insertion port 21 includes an annular aperture as well as an elongated slot extending to the aperture.

FIGS. 4A-4C illustrate how the disclosed vial adapter 16 is attached to a vial 22 filled with injectable fluid 25. A transverse or radial technique 23 involves insertion of vial 22 via the radial insertion port 20 (see FIG. 3A). An axial technique 24 involves insertion of the vial 22 through the axial insertion port at the bottom of the vial adapter 16, moving the vial 22 in a direction toward the spacing disc 17.

In FIG. 5 are different views of vial adapter 16 to illustrate different elements of the device to describe their utility. This embodiment, the radial insertion port 20 referenced earlier is framed by side flaps 27 and top flaps 27. When the vial is inserted radially, the side flaps 27 flex out radially to accommodate the larger diameter of the vial stopper retainer and resiliently relax once the vial is coaxial with the vial adapter 16 thereby also radially retaining it. Additional radial retention features may be circularly arranged except for the radial insertion port 20. The vial can also be pulled out radially through the radial insertion port allowing for storage after a single use or to reuse with another vial. The side flaps 27 similarly radially flex out to facilitate removal of the vial. This reusability feature is important from a sustainability standpoint, but also in instances where rapid scale up is necessary.

The vial adapter 19 further includes features to retain the vial axially within the vial retainer 19. For example, the vial retainer 16 and/or the spacing arm 18 may include structures that engage along surfaces of the stopper retainer 3 of the vial. In the illustrated embodiment, axial retention of a vial is accomplished by radially arranged axial retention features 33 that may be disposed along a lower edge of the stopper retainer 3, and an opposing axial retention feature 32 and the top flaps 27 that may be disposed along an upper surface or edge of the stopper retainer 3. The radial location of the radially arranged axial retention features 33 are such that they are equal or slightly less than the radius of the neck 28 (shown in FIG. 1) portion of the vial, but less than both the radii of barrel 30 and rim 29 (both also in FIG. 1) of the vial. These axial retention features radial contact the portion under the neck 5 (see FIG. 1) of the vial. The axial distance between a flat on retention feature 32, which faces the axial vial insertion port side and tip of the radially arranged axial retention features 33, is equal to or slightly less than sum of height of vial rim 29, stopper retainer 3 thickness and thickness of portion of vial stopper 2 resting on the top of rim 29 (see FIG. 1). All radial retention features have thickness such that they can flex radially or axially to accommodate oversized dimension of feature they are constraining. Top flaps 27 also axially constrain the vial in the same direction as retention feature 32.

Top flaps 27 also provide additional stability during operation of the device, especially when the transfer needle is being inserted through needle insertion port 21′ of the spacing disk 13. Needle insertion port 21′ shown in FIG. 5 is an annular aperture, that is, the needle insertion port 21′ is framed completely by the spacing disk 13. There could optionally be a cut out or channel extending from the aperture, as shown in needle insertion port 21 in FIG. 3. The angle of the axis of the cross section of vial retainer portion of the device and spacing arm 18 dictates the angle of insertion of the needle into the vial. Illustrated here is a coaxial insertion (0 degree angle)—i.e., the transfer needle and vial are coaxial.

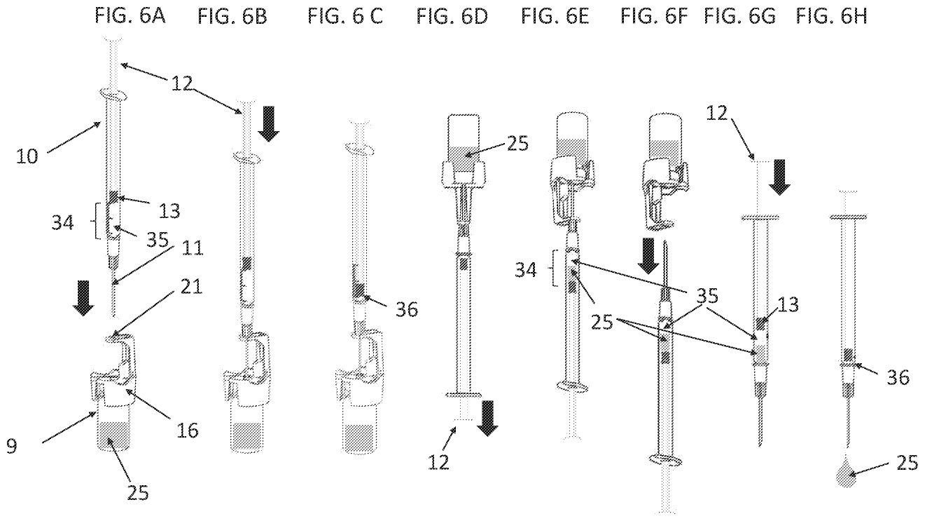

FIGS. 6A-6H show various steps to use the vial adapter 16 to draw injectable fluid 25 from vial 9 using a syringe 10 and transfer needle 11. The steps of use illustrate the inventive method of injectable fluid transfer and subsequent administration with maximized efficiency and minimized waste of injectable fluid. While this inventive method ideally may or may not be used in conjunction with the vial adapter 16.

FIG. 6A shows a syringe 10 with attached needle 11 where the plunger seal 13 is drawn by an amount 34 corresponding to the intended injection volume. The corresponding axial distance traversed by the plunger rod 12 is the “draw stroke”. Air 35 is now adjacent to the plunger seal 13. The transfer needle 11 is inserted through the needle insertion port 21 towards the vial 9.

Referring to FIG. 6B, once the needle 11 is bottomed out, i.e., the base of the needle 11 is seated against the spacing disc, the tip of the needle 11 is inside the vial 9 past its septum. In this way, the axial location of the needle tip is determined by the vial adapter 16. The user then depresses plunger rod 12 to inject air 35 inside the vial 9. Transferring drug from a vial to a syringe involves subtracting of volume from the vial, which results in negative pressure in the vial and increasing resistance to transferring injectable fluid out of the vial. Pressurizing the vial is best practice and optional; this is not possible in some types of syringes such as auto disable syringes used for immunization in low- and middle-income countries. The volume of air to pressurize the vial may typically be 10-30% lower than the intended volume to be transferred out of the vial in some scenarios.

FIG. 6C shows the plunger seal 13 at the end of dose position 36 with air 35 transferred to the inside of the vial 9. While in the same axial position relative to each other, the orientation is inverted as shown in FIG. 6D, such that the injectable fluid 25 is now adjacent to the needle tip, which is still embedded in and has pierced the vial septum. In FIG. 6E, plunger rod 12 is drawn by a axial distance equal to the draw stroke 34, which corresponds to a volume equal to the intended injection volume. This results in transfer of injectable fluid 25 from the vial 9 into the syringe 10. Expected volume of injectable fluid 25 transferred into the syringe 10 is equal to the intended injection volume; some portion of this is in the transfer needle 11. In some cases where the volume of injectable fluid (incompressible component) is so large that very little air compressible component) is contained in the vial, the draw stroke 34 imparted by the user may be larger than the intended dose volume to provide sufficient negative pressure to drive flow of intended volume from vial 9 into the syringe 10. The increase stroke can be determined based on vial capacity, vial fill volume and intended injection volume.

FIG. 6F shows detachment of the injection needle 11 from the vial 9 and the attached device 16. Visible within the syringe is injectable fluid 25 and air 35. The orientation prior to detachment could be inverted relative to what is illustrated in FIG. 6F.

Shown in FIG. 6G, the air 35 in the syringe 10 is manipulated such that the air is proximal to the plunger seal 13. The volume of this air is equivalent to the cumulative dead space of the syringe 10 and transfer needle 11. Illustrated here is the transfer needle 11 is also the injection needle. The needle is inserted, preferably vertically, into the administration site and the plunger rod 12 is depressed until the plunger seal 13 is aligned with end of dose position 36 (usually the “0” mark on the syringe). This is shown in FIG. 6H and results in injection of injectable fluid 25 having volume equal to the intended dose volume. When the needle is inserted vertically, the air 35 corresponding to the dead space is almost entirely retained in the syringe 10 and needle 11, thereby counteracting the effect of dead space that results in waste of drug. The orientation of administration is such that the air 35 always remains proximal to the plunger seal 13.

In some applications, it is possible that the injection needle (or injection conduit such as a catheter, injection port, etc.) is different than the transfer needle. In this case, the volume corresponding to the draw stroke illustrated in FIG. 6D is the sum of intended dose volume and dead space of the transfer needle 11. The injection step of FIG. 6G is preceded by substitution of transfer needle with the injection conduit. The injection stroke is immediately preceded by a prime stroke equal to the dead space of the injection conduit. If the dead space of the injection conduit is greater than dead space of the transfer needle, the draw stroke illustrated in FIG. 6D is the sum of intended dose volume and the dead space of the injection conduit.

In some instances where bubbles form in the formulation because of the presence of surfactants and other surface tension decreasing excipients, the draw stroke can be slightly larger (5-10%) than the volumes corresponding to the aforementioned draw strokes in different scenarios. This allows the dead space of the syringe and the needle to act as a bubble trap and minimize the amount of time a physician needs to spend to get rid of the bubble.

In case of the where drug is prefilled in the syringe, steps illustrated in FIGS. 6G and 6H would be applicable with possibility of a prime stroke as described above.

This disclosure further envisions an embodiment where the total draw stroke volume is greater than the sum of the primed volume and the intended dose volume. In some applications, when the dead space of the delivery conduit is much larger than the dead space of the transfer needle or the syringe or the intended injection volume, the transfer of injectable fluid from a vial to a syringe is preceded by transfer of air into syringe. In this case the total air in the syringe prior to injectable fluid transfer from a vial is greater than the dead space of the syringe.

In applications where the injectable fluid has very high viscosity (˜30 to 1000 times more viscous than water), it would be challenging to create sufficient differential pressure to facilitate flow of the injectable fluid from the vial to the syringe. In such applications it is envisioned that step of pressurizing the vial 9 (shown in FIGS. 6B and 6C) is performed by a large volume pressurizing syringe (such as VacLok® Syringe from Merit Medical) and needle different from the syringe 10 and needle 11 used to administer the injectable fluid. This VacLok® Syringe can help inject 30-60 times the intended injection volume. When removed, a large positive pressure is created inside the vial with injectable fluid at the end of step corresponding to FIG. 6C. the VacLok® Syringe is replaced by the syringe 10 having needle 11. When the needle 11 is inserted into the vial in orientation and configuration depicted in FIG. 6D, the high pressure in the vial helps provide the necessary pressure differential for the viscous injectable fluid to transfer from the vial 9 into the syringe 11. Subsequent steps can be same as that illustrated in FIGS. 6F through 6H.

In some applications, it may be beneficial to package and transport the vial adapter along with the drug vial to ensure that the device is always and readily available for use. Vials constructed using glass can shatter and be damaged during packaging or transport. It would be beneficial to shield the fragile vial from impact. The vial adaptor device disclosed here had three modules—Spacing disc, Spacing Arm and Vial retainer. The three were rigidly connected to each other in the embodiment described thus far.

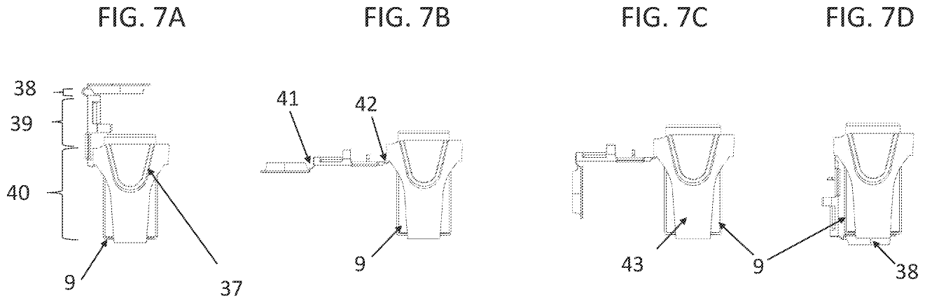

Shown in FIGS. 7A-7D is a vial adaptor 37 (Embodiment 2) equivalent to previously described vial adapter 16 (Embodiment 1) in terms of function for transferring injectable fluid from a vial to a syringe. Vial adapter 37 has equivalent spacing disc 38, spacing arm 39 and vial retainer 40. In order to add more functionality, the vial adapter 37 includes one or more flexible living hinges, allowing the vial adapter 37 to be more compactly stored, for example. In the illustrated embodiment, the spacing disc 38 is connected to spacing arm 39 with a flexible living hinge 41, and spacing arm 39 is connected to vial retainer 40 with flexible living hinge 42. The term “living hinge” may refer to, for example, a thinned, flexible portion which allows the adjacent structures to pivot relative to one another. The flexible living hinges 41, 42 of this embodiment enable the adjacent portions of the structure to pivot up to 180 degrees relative to one another, changing the angle between the portions of the structure that the living hinge connects. The configuration shown in FIG. 7A is equivalent to use for transferring injectable fluid from vial 9 as described for Embodiment 1. The user has the option after one withdrawal to disengage the spacing disc 38 from the spacing arm 39 while still connected by a living hinge 41. The user can concurrently or successively disengage spacing arm 39 from vial retainer 40 while still connected by living hinge 42. Shown in FIG. 7D, the angle between the spacing disc 38 and spacing arm 39 is 180 degrees different than same in FIG. 7A. The spacing disc 38 snaps into flaps 43 on vial retainer 40. Also, in FIG. 7D the angle between the spacing arm and vial retainer is 180 degrees different than same in FIG. 7A. This functionality enables compact storage (and transportation) of the vial adaptor 37 and the vial 9 together, as visually illustrated in FIG. 7D.

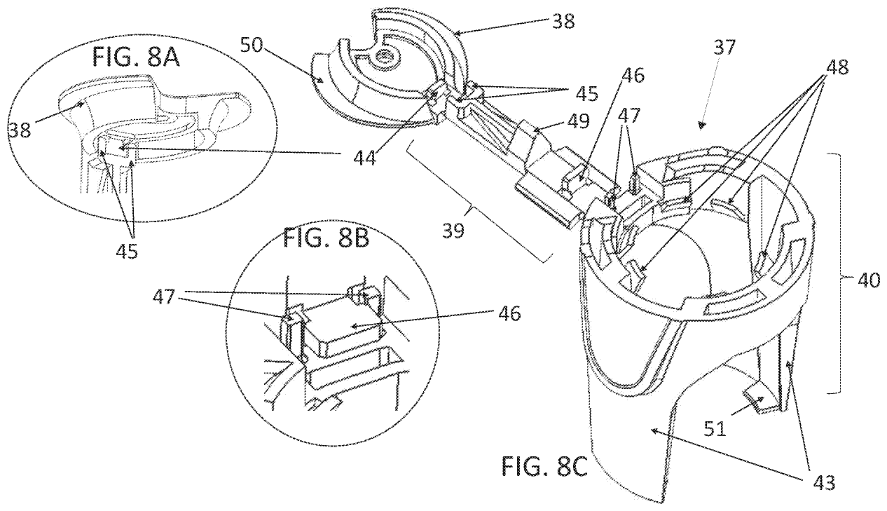

FIGS. 8A-8C illustrates how spacing disc 38 and spacing arm 39 may interlock to provide a sturdy, static structure despite a flexible hinge connecting portions of the vial adapter 37. More in this embodiment, tab 44 of the spacing disc 38 is interlock in an interference fit in the gap between rigid posts 45 of the spacing arm 39, providing a fixed structure between the spacing arm 39 and the spacing disk 38. Illustrated also is how tab 46 on the spacing arm 39 interferes with posts 47 on the vial retainer 40 (see FIG. 8B). The posts 47 flex out slightly when the tab 46 is inserted prior to device operation and when the user detaching the interlocks prior to storage. Also shown are axial retention feature 49 on the spacing arm 39 and axial retention features 48 on the vial retainer 40. The vial is axially constrained between 48 and 49. Radial constraint to the vial is provided by flaps 43. In the storage/transport configuration (shown FIG. 7D), the part 50 of the spacing disc 38 interlock with tab 51 on each of the flaps 43.

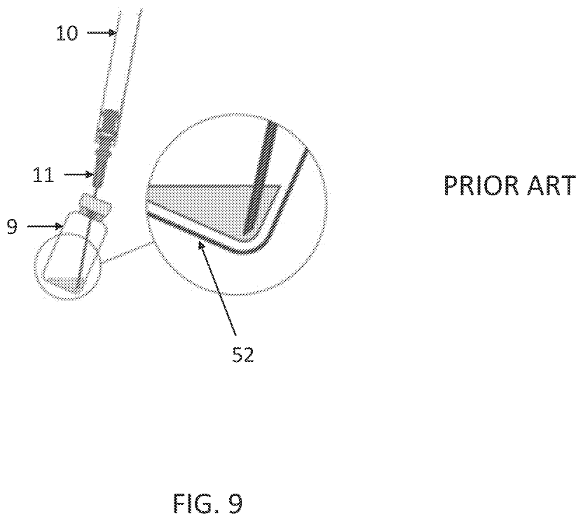

Turning to FIG. 9, in some applications, the amount of injectable fluid in a vial is too low for the vial to be inverted when transferring from a vial to a syringe 10 using a needle 11. The amount of the injectable fluid is also too low for the base 52 of vial 9 to be placed flat on a surface because doing so will result in an injectable fluid liquid column of very low height. This low height will make it extremely difficult to transfer injection fluid. One method that has been employed (shown in FIG. 9 is part of instructions for drawing Beovu®) involved tilting the vial 9 such that the edge between the cylindrical part and the base 52 creates a well as shown in FIG. 9. This well makes it easier for the needle tip to be submerged under the injectable fluid contained in the vial 9.

The burden is on the user to maintain the right angle of tilt of the vial and positioning the needle tip at the precise location of the deepest point of the injectable fluid well at the said angle.

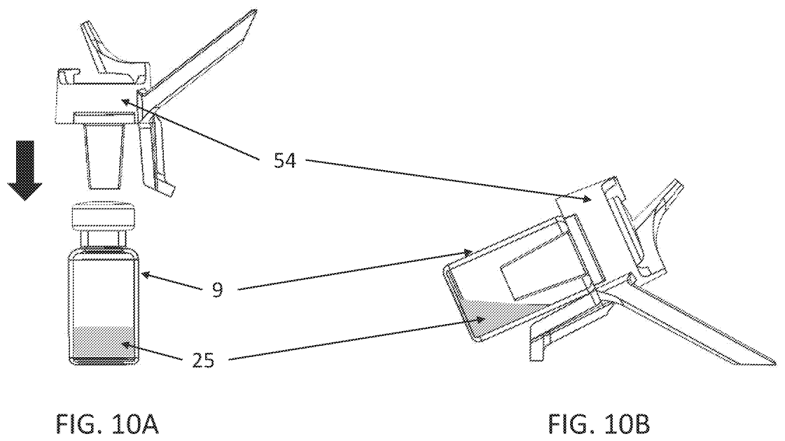

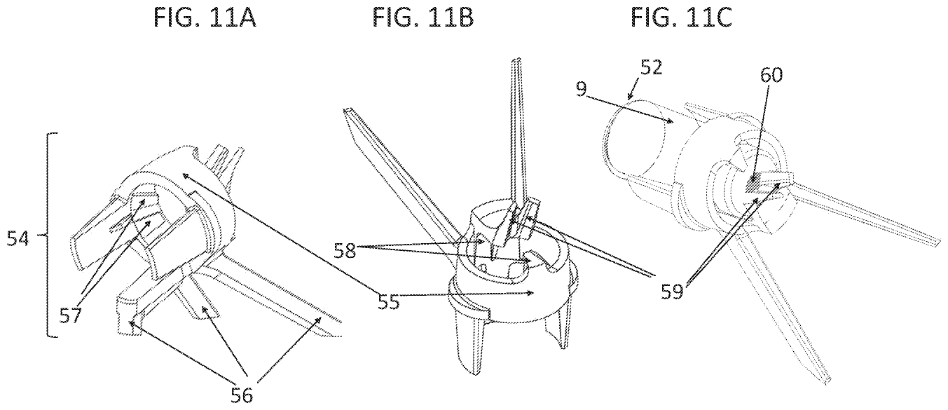

According to another aspect of this disclosure, a vial adapter 54 that may be utilized to positioning of a vial 9 to facilitate access to such small volumes of injectable fluid 25 remaining in the bottom of a vial 9. Shown in FIGS. 10A and 10B, as well as FIGS. 11A-11C, is an embodiment (embodiment 3) of a vial adapter 54 that is axially applied to a vial 9 containing injectable fluid 25. The vial adapter 54 helps control the angle of transfer needle (not shown in FIG. 10) relative to the axis of the vial 9, and guide the needle tip to the bottom of injectable fluid well.

FIGS. 11A-11C provide different views of the vial adaptor 54, FIG. 11C illustrating the vial adapter 54 attached to a vial 9. In order to orient the vial 9 for a specific angle of the insertion of the needle (not illustrated), the vial adapter 54 includes a vial retainer 55 from which a support structure extends for supporting the vial 9 and vial adapter 54 at an angle less than 90° on a surface. In the illustrated embodiment, the support structure is in the form of a plurality of legs 56 extending from the vial retainer 55. In this way, the vial 9 within the vial retainer 55 is supported on a surface at a specified angle by the legs 56. While the illustrated vial adapter 54 includes three legs 56, those of skill in the art will appreciate that the vial adapter 54 may include an alternative number of legs, such as four, or the support structure may be a single angled leg or wedge.

The vial is radially constrained by vial retainer 55 of the adapter device 54, the vial retainer 55 presenting a generally cylindrical structure. The vial 9 may be axially retained within the vial retainer 55 by and between axial retention features 57 and 58. The vial may be inserted from the side shown in FIG. 11A.

The vial adapter 54 may further provide guidance for insertion of a transfer needle (not illustrate) into the vial 9 in an optimal position for removal of injectable fluid 25 from the lowermost portion of the vial 9. A guide for a needle is provided by needle guide features 59; these needle guide features 59 help direct the user to orient the needle towards the vial septum 60. The needle guide features 59 may be in the form one or more structures disposed with an upper surface disposed at an angle that is complimentary to and dependent upon, the angle at which the legs 56 dispose the vial 9, and the size of the vial 9 itself. In this way, the needle guided by the needle guide features 59 will pierce the vial septum 60 and end of the needle will be disposed in the lowermost portion of the positioned vial 9.

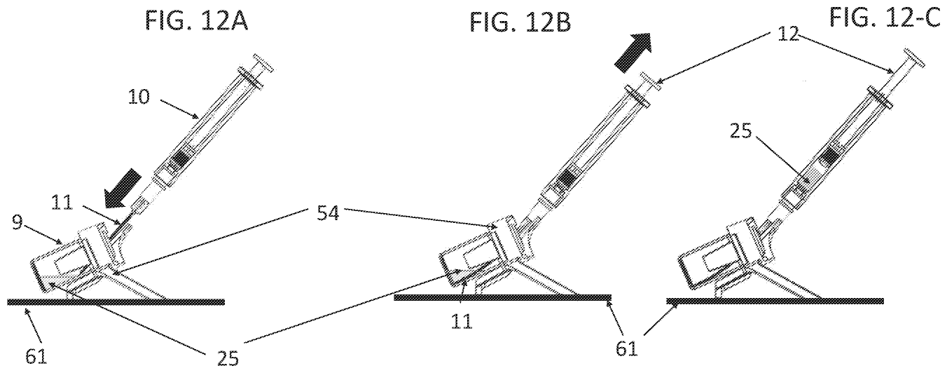

FIGS. 12A-12C show different stages of operation to transfer injectable fluid 25 from vial 9 into syringe 10 using a needle 11 using this this embodiment of the vial adapter device 54. Shown in FIG. 12A is vial 9 with injectable fluid 25 incorporated into vial adapter 54 and placed on a flat surface 60. A syringe 10 with attached transfer needle 11 is guided at a specific range of angles determined by vial adapter 54. Shown in FIG. 12B is that the needle 11 is further guided by the cylindrical wall of vial 9 directing its tip to the bottom of the injectable fluid 25 well at the intersection of the base and cylindrical portion of the vial. The plunger rod 12 is withdrawn to transfer the injectable fluid 25 from the vial 9 into syringe 25 (see FIG. 12C).

Once the injectable fluid 25 is transferred into the syringe the inventive method disclosed herein or a conventional method may be employed to administer the injectable fluid 25.

### INDUSTRIAL APPLICABILITY

The disclosed invention covers a device for pre-deterministic placement of the needle tip, methods to counteract the effect of dead space in injection systems and/or combinations thereof.

The disclosed invention describes methods to minimize the impact of dead space inherent in the transfer and injection of injectable therapies. In applications where the injection needle is also used to transfer drug from the vial, the disclosed inventive approach minimizes the impact of dead space to fill volumes by prescribing methods where air occupying the dead spaces at the outset is not substituted by liquid drug. The user can axially translate the plunger rod in the non-needle direction (this is the “draw stroke”) corresponding to exactly the intended injection dose volume. This transfers drug from the vial corresponding to the intended dose volume into the needle and syringe. The liquid level in the syringe would be lower than marking corresponding to the amount of the intended dose by an amount equal to the dead space. When the needle is oriented down (typical injection direction, the space between the liquid level and the plunger stopper is air. When the injection needle is inserted into the injection site and the plunger is depressed until its bottomed out, the volume dispensed is equal to the volume transferred from the vial, which in turn is equal to the intended dose volume. Barring negligible inefficiencies and for formulations involving viscosities similar to water, the overfill requirement attributable to syringe and injection needle dead space can potentially be reduced to almost “zero”. Any inefficiency in the disclosed method is marginal relative to the state of the art. This benefit is multiplied in case of a multi dose vial.

As volume is subtracted from the vial, negative pressure is created in the vial which can impact the efficiency of the proposed approach. This is truer in case of large volume of drug transfer relative to the total vial fill volume. This issue is less applicable when the volume of drug transfer is small relative to the total vial fill volume. This behavior is consistent with Boyle's Law. In order to mitigate effects of negative pressure, two approaches are envisioned. First approach is to use a needle to vent and equilibrate the pressure. The venting needle may have a filter to exclude ambient particulates or microorganisms. The second approach involves drawing air (filtered or ambient) into the syringe prior to insertion of the needle into the stopper. Once the needle tip is in the vial, the aforementioned air is injected into the vial, pressurizing the drug chamber in the vial. The volume of air injection should be close to the volume of drug to be drawn from the vial. This innovative approach would mitigate the aforementioned negative pressure challenge.

Disclosed invention also includes a vial adapter that can be used with a multi dose vial (MDV) or a single dose vial (SDV). The vial adapter for use with a multi dose vial provides several benefits. The method disclosed above to mitigate challenges with dead space can be limited with a multi dose vial in the last few doses to be drawn from the vial. Success with the proposed method is predicated on ability to draw liquid drug only during the draw step. Since visualization of the liquid level is challenging when the total or remaining volume in the vial is below the line of sight obscured by the stopper and the stopper retainer. Here, fidelity of proposed method is contingent on precise and stable positioning of the needle tip within the vial (just past the stopper); this is facilitated by the disclosed vial adapter. The vial adapter enables use of conventional draw orientation independent of vial fill volume. Unlike conventional vial adapters in the prior art that include a spike to penetrate the vial stopper, the vial adapter disclosed here does not breach the drug chamber and hence can remain attached to the vial prior to receipt by the intended end user. The disclosed adapter has a hinge feature to enable sanitizing steps between use similar to that employed to sanitize the stopper between uses. The hinge feature also allows for the vial adapter to be attached to the vial even without removing the plastic lid. The ratchet features on the vial adapter ensure secure axial positioning of the vial adapter for optimal performance.

The disclosed invention covers various embodiments of a vial adapter that connect to an injectable fluid vial. Also disclosed are methods of injectable fluid transfer from a vial using a transfer needle and subsequent injection of the injectable fluid through a delivery conduit. In some applications, the transfer needle and the delivery conduit may be the same.

Hence, an innovation such as the one disclosed here, that can help deliver a complete dose and minimize (or eliminate) overfill should be acceptable from a regulatory standpoint.

For the purposes of this disclosure, the term “substantially” is to be interpreted as +/−10% where applicable.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A vial adapter for use with an injector and a vial containing an injectable fluid, the vial including a stopper and a stopper retainer, the injector including a barrel and a needle, the vial adapter comprising:
a vial retainer, the vial retainer having a generally cylindrical structure having a central opening and being sized to receive at least a portion of the vial, the stopper and the stopper retainer,
a spacing disc, the spacing disc including a needle insertion port, the needle insertion port being sized to permit the passage of the needle and not to allow the passage of the barrel, and
a spacing arm attached to the vial retainer and the spacing disc, the spacing arm being sized to space the spacing disc a predetermined distance from the vial retainer,
wherein when the needle of the injector is inserted through the needle insertion port and into the stopper, a distance that the needle may extend through the stopper is limited by contact of the injector with the spacing disc.

2. The vial adapter of claim 1 wherein an angle at which the needle pierces the stopper is determined by at least one of an angle of at least one surface of the spacing disc to the stopper or a disposition of the spacing disc relative to the vial retainer.

3. The vial adapter of claim 1 wherein the vial retainer includes at least one radial opening through the cylindrical structure, the vial retainer being resilient such that at least a portion of the vial, the stopper and the stopper retainer may be advanced in a radial direction through the radial opening into the central opening of the vial retainer.

4. The vial adapter of claim 1 wherein the vial retainer is resilient such that at least a portion of the vial, the stopper and the stopper retainer may be advanced in an axial direction into the central opening of the vial retainer.

5. The vial adapter of claim 1 wherein at least one axial retention feature, said axial retention feature being disposed to engage at least one surface of at least one of the vial and the stopper retainer to minimize axial movement of the vial within the vial retainer.

6. The vial adapter of claim 5 wherein the at least one axial retention feature includes at least one surface that confronts an upper surface of the stopper retainer, and at least one surface that confronts a lower surface of at least one of the stopper retainer and the vial.

7. The vial adapter of claim 1 further including at least one living hinge disposed between the spacing arm and at least one of the spacing disc and the vial retainer.

8. The vial adapter of claim 7 wherein the at least one living hinge provides at most 180° of movement between the spacing arm and the at least one of the spacing disc and the vial retainer.

9. The vial adapter of claim 7 wherein including a first living hinge between the spacing arm and the spacing disc and a second living hinge between the spacing arm and the vial retainer, the first and second living hinges allowing the vial adapter to mover between a use position and a storage position.

10. The vial adapter of claim 7 further including at least one engaging structure disposed to maintain the living hinge disposed between the spacing arm and at least one of the spacing disc and the vial retainer in at least one of a use position and a storage position.

11. The vial adapter of claim 1 further including a support structure disposed to support the vial retainer and vial at an angle of less than 90° on a surface.

12. The vial adapter of claim 11 wherein the support structure includes a plurality of legs.

13. The vial adapter of claim 1 wherein the vial adapter is reusable on said vial or a different vial.

14. The vial adapter of claim 1 wherein the vial adapter may be irreversibly attached to a vial.

15. A method of administering a single dose of an injectable fluid to a target comprising:
transferring a single dose of the injectable fluid to an injector, the injector having dead space containing dead space air,
positioning the injector in an orientation with the injectable fluid proximal to an injection needle or cannula of the injector and the dead space air proximal to a plunger of the injector, and positioning the injector over a target,
inserting an injection needle of the injector into the target while maintaining the injector in said orientation,
administering the injectable fluid to the target while maintaining the injectable fluid proximal to the injection needle or cannula of the injector and the dead space air proximal to the plunger of the injector, and
removing the injection needle or cannula from the target while substantially maintaining the dead space air within the injector.

16. The method of claim 15 wherein the total volume of injectable fluid transferred from vial into injector is less than the sum of intended volume and the injector dead space

17. A method of transfer and administration of injectable fluid wherein, transfer from a vial into an injector involves injection of air from the injector into the vial approximately equal to intended dose volume followed by an injector draw stroke substantially equal to the intended dose volume, followed by administration of injectable fluid such that volume of air substantially equal to dead space of the injector is retained in the injector at the end of delivery of injectable fluid.

18. The method of claim 17 wherein the draw stroke substantially equal to sum of intended injection volume and dead space of the needle or injection conduit, is followed by a prime stroke corresponding to volume of dead space of injection conduit, is then followed by an injection stroke corresponding to intended injection volume.

19. The method of claim 17 wherein the injection of air into the vial is ten times greater than intended injection volume of an injectable fluid having viscosity thirty times greater than water or more.

20. Vial having injectable fluid total fill volume less than a sum of an intended volume or volumes and 0.1 mL or a number of intended doses times 0.1 mL respectively.
